(19) United States
(12) Patent Application Publication
(10) Pub. No.: US 2019/0345745 A1
(43) Pub. Date: Nov. 14, 2019

(54) VEHICLE DOOR LATCH UNLOCKING DEVICE

(71) Applicant: TOYOTA JIDOSHA KABUSHIKI KAISHA, Toyota-shi (JP)

(72) Inventors: Kazuki MURATA, Toyota-shi (JP); Tatsuya SHIMIZU, Okazaki-shi (JP); Tadao OKUMURA, Nagoya-shi (JP); Noriyo INAGAKI, Anjo-shi (JP)

(73) Assignee: TOYOTA JIDOSHA KABUSHIKI KAISHA, Toyota-shi, Aichi-ken (JP)

(21) Appl. No.: 16/381,181

(22) Filed: Apr. 11, 2019

(30) Foreign Application Priority Data
May 8, 2018 (JP) 2018-089726

(51) Int. Cl. E05B 81/04; E05B 81/16; E05B 81/76; E05B 85/12; E05B 85/16

(52) U.S. Cl. CPC E05B 81/04; E05B 81/16; E05B 85/16; E05B 85/12; E05B 81/76

(57) ABSTRACT

A vehicle door latch unlocking device includes: an input section that is provided to a vehicle cabin interior side portion of a vehicle door, the input section being capable of outputting an input signal in response to an input from a hand of an occupant; an electric actuator that is driven based on the input signal, and that is capable of unlocking a lock state of the vehicle door locked by a door latch; and an operation section that is provided at a peripheral edge portion of the input section, the operation section being mechanically connected to the door latch, and being capable of unlocking the locked state as a result of being operated by the hand of the occupant.

### CROSS-REFERENCE TO RELATED APPLICATION

This application is based on and claims priority under 35 USC 119 from Japanese Patent Application No. 2018-089726 filed on May 8, 2018, the disclosure of which is incorporated by reference herein.

### BACKGROUND

### Technical Field

The present disclosure relates to a vehicle door latch unlocking device.

### Related Art

Japanese Patent Application Laid-Open (JP-A) No. 2014-15764 discloses technology relating to a vehicle door latch unlocking device. In this vehicle door latch unlocking device, an inside handle is attached to a vehicle door so as to be capable of turning about the door thickness direction. A push button is provided to the inside handle. When an occupant operates the push button in a normal operation, an electric actuator is actuated so as to unlock a locked state of the vehicle door by a door latch.

When the electric actuator does not actuate correctly, for example due to its battery running flat, the locked state of the vehicle door by the door latch is unlocked mechanically by an emergency operation in which the push button is pushed in by a larger stroke than in the normal operation.

In a configuration such as that described above, the occupant operates the push button to unlock the locked state of the vehicle door by the door latch, irrespective of the actuation state of the electric actuator. It is conceivable that the occupant might operate the push button by pushing the push button in further than is necessary, namely perform the emergency operation, even though the electric actuator is in a state capable of actuating.

Regarding this point, in the technology of JP-A No. 2014-15764, a restriction-release operation member is provided to the inside handle. In a disabled state of the restriction-release operation member, emergency operation of the push button is restricted. In a state in which the restriction-release operation member has been operated by an occupant, emergency operation of the push button is permitted.

However, in the technology of JP-A No. 2014-15764, in the disabled state of the electric actuator, it is necessary for an occupant to operate the push button and the restriction-release operation member at the same time in order to unlock the locked state of the vehicle door by the door latch. Accordingly, in the disabled state of the electric actuator, it might conceivably be difficult for the occupant to intuitively recognize the operation necessary in order to unlock the locked state of the vehicle door by the door latch. Namely, in the technology of JP-A No. 2014-15764, there is room for improvement in terms of simplifying the operation required in order to unlock the locked state of the vehicle door by the door latch when the electric actuator is in the disabled state, while enabling the occupant to intuitively recognize this operation.

### SUMMARY

In consideration of the above circumstances, the present disclosure provides a vehicle door latch unlocking device capable of simplifying an operation required in order to unlock a locked state of a vehicle door by a door latch in a disabled state of an electric actuator, while enabling an occupant to intuitively recognize this operation.

An aspect of the present disclosure is a vehicle door latch unlocking device including an input section that is provided to a vehicle cabin interior side portion of a vehicle door, the input section being actuated and outputting an input signal in response to an input from a hand of an occupant; an electric actuator that is driven based on the input signal, and that is capable of unlocking a lock state of the vehicle door locked by a door latch; and an operation section that is provided at a peripheral edge portion of the input section, the operation section being mechanically connected to the door latch, and being capable of unlocking the locked state as a result of being operated by the hand of the occupant.

In the aspect, the input section is provided to the vehicle cabin interior side portion of the vehicle door. When the input section receives input from the hand of the occupant, the input section actuates based on this input and outputs an input signal. The electric actuator is then driven based on the input signal output from the input section, and the locked state of the vehicle door by the door latch is unlocked.

In a state in which the electric actuator does not actuate correctly, for example due to its battery running flat, it becomes necessary to unlock the locked state of the vehicle door by the door latch without using electricity. It is preferable that the occupant be able to intuitively recognize the operation required in order to unlock the locked state of the door latch.

The aspect includes the operation section that is mechanically connected to the door latch, such that the locked state of the vehicle door by the door latch may be unlocked by operation of the operation section by the hand of the occupant. Accordingly, the locked state of the vehicle door by the door latch may be unlocked by the occupant operating the operation section, even in a state in which the electric actuator does not actuate correctly. Moreover, the operation section is provided at the peripheral edge portion of the input section, making it easier for the occupant to recognize that the operation section is to be used to unlock the locked state of the vehicle door by the door latch, similarly to the input section.

Accordingly, the vehicle door latch unlocking device according to the aspect enables the operation required in order to unlock the locked state of the vehicle door by the door latch in a disabled state of the electric actuator to be simplified, and also enables the occupant to intuitively recognize this operation.

The aspect may be configured such that the input section is actuated by being pressed by the hand of the occupant; and the operation section becomes operable by being turned by force in a direction in which the input section is pressed by the hand of the occupant.

In the above configuration, the input section is actuated by being pressed by the hand of the occupant, and the operation section is operated by being turned by force in the direction in which the input section is pressed by the hand of the occupant. The direction of input by the hand of the occupant may thus be set to the same direction for the input section and the operation section.

Accordingly, the above configuration enables the occupant to easily recognize the operation method of the operation section.

The aspect may be configured so as to further include a frame that is provided to a vehicle cabin interior side portion of the vehicle door, wherein the input section and the operation section are contained at an inner side of the frame when viewed by the occupant in a seated state on a vehicle seat.

In the above configuration, the frame is provided to the vehicle cabin interior side portion of the vehicle door. The input section and the operation section are contained at the inner side of the frame when viewed by the occupant in the seated state on the vehicle seat. This makes it easier for the occupant to recognize the presence of the operation section, and makes it easier to recognize that the operation section has a function similar to that of the input section.

The above configuration thereby enables the occupant to easily recognize the location to be operated in order to unlock the locked state of the vehicle door by the door latch in a state in which the electric actuator does not actuate correctly.

The aspect may be configured so as to further include an armrest that is provided to a vehicle cabin interior side portion of the vehicle door, and that comprises a pull handle, wherein the input section and the operation section are disposed at a side face on a vehicle width direction inner side of the pull handle.

In the above configuration, the armrest including the pull handle is provided at the vehicle cabin interior side portion of the vehicle door. The input section and the operation section are disposed at the side face on the vehicle width direction inner side of the pull handle. This thereby enables the occupant to apply input to the input section or operate the operation section while grasping the pull handle.

Accordingly, the above configuration enables a smooth operation for the occupant from the operation to unlock the locked state of the vehicle door by the door latch until opening of the vehicle door.

The aspect may be configured such that a recess is provided to the pull handle so as to be recessed toward a vehicle width direction outer side at the inner side of the frame as viewed from the vehicle width direction inner side.

In the above configuration, the recess is provided to the pull handle. The recess is positioned at the inner side of the frame as viewed from the vehicle width direction inner side, and is recessed toward the vehicle width direction outer side. This enables a space into which the occupant is able to insert a finger of their hand to be secured at a location where the operation section is provided to the pull handle, and thereby enables the occupant to hook the finger of their hand around the operation section to operate the operation section.

The exemplary embodiment thereby enables easy operation of the operation section while the occupant is grasping the pull handle.

The aspect may be configured such that the operation section has a frame shape as viewed from the vehicle width direction inner side; a vehicle rear side portion of the operation section is supported by the pull handle so as to be capable of turning about a vehicle vertical direction; and a vehicle front side portion of the operation section is disposed at a separation in a vehicle front-rear direction from a vehicle front side portion of the frame.

In the above configuration, the operation section has a frame shape as viewed from the vehicle width direction inner side, and the vehicle rear side portion of the operation section is supported by the pull handle so as to be capable of turning about the vehicle vertical direction. The vehicle front side portion of the operation section is disposed at the separation D in the vehicle front-rear direction from the vehicle front side portion of the frame. This thereby enables the occupant to turn the operation section about the vehicle vertical direction while the occupant is grasping the pull handle and has inserted a finger of their hand between the vehicle front side portion of the frame and the vehicle front side portion of the operation section.

The above configuration thereby enables the ease of operation of the operation section to be improved.

### BRIEF DESCRIPTION OF THE DRAWINGS

FIG. 1 is a perspective view illustrating configuration of an inside handle and portions peripheral thereto in a vehicle door latch unlocking device according to a first exemplary embodiment, as viewed from a vehicle cabin interior side;

FIG. 2 is a perspective view illustrating configuration of the inside handle and a push switch of the vehicle door latch unlocking device according to the first exemplary embodiment, as viewed from the vehicle cabin interior side;

FIG. 3 is a perspective view illustrating configuration of the inside handle and the push switch of the vehicle door latch unlocking device according to the first exemplary embodiment, as viewed from the vehicle cabin exterior side;

FIG. 4 is a side view illustrating configuration of a door trim provided with the vehicle door latch unlocking device according to the first exemplary embodiment, as viewed from a vehicle width direction inner side;

FIG. 5 is a side view schematically illustrating configuration of the vehicle door latch unlocking device according to the first exemplary embodiment as viewed from the vehicle width direction inner side;

FIG. 6 is a side view schematically illustrating configuration of the inside handle, the push switch, and a bezel of the vehicle door latch unlocking device according to the first exemplary embodiment, as viewed from the vehicle width direction inner side;

FIG. 7 is a side view schematically illustrating configuration of an inside handle, a push switch, and a bezel of a vehicle door latch unlocking device according to a modified example of the first exemplary embodiment, as viewed from the vehicle width direction inner side;

FIG. 8 is a side view schematically illustrating configuration of an inside handle, a push switch, and a bezel of a vehicle door latch unlocking device according to a second exemplary embodiment, as viewed from the vehicle width direction inner side;

FIG. 9 is a side view schematically illustrating configuration of an inside handle, a push switch, and a bezel of a vehicle door latch unlocking device according to a first modified example of the second exemplary embodiment, as viewed from the vehicle width direction inner side; and

FIG. 10 is a side view schematically illustrating configuration of an inside handle, a push switch, and a bezel of a vehicle door latch unlocking device according to a second modified example of the second exemplary embodiment, as viewed from the vehicle width direction inner side.

### DETAILED DESCRIPTION

### First Exemplary Embodiment

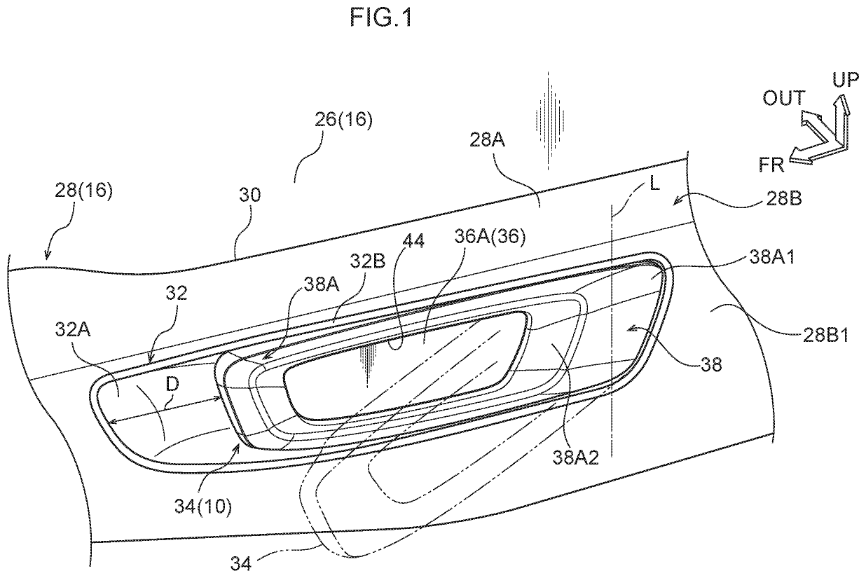

Explanation follows regarding a first exemplary embodiment of a vehicle door latch unlocking device according to the present disclosure, with reference to FIG. 1 to FIG. 7. In the drawings, the arrow FR indicates a vehicle front side, the arrow UP indicates a vehicle upper side, and the arrow OUT indicates a vehicle width direction right side.

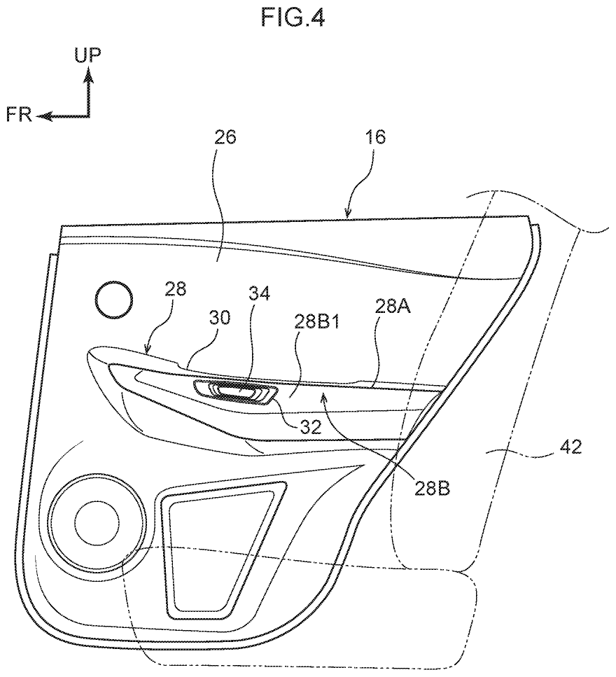

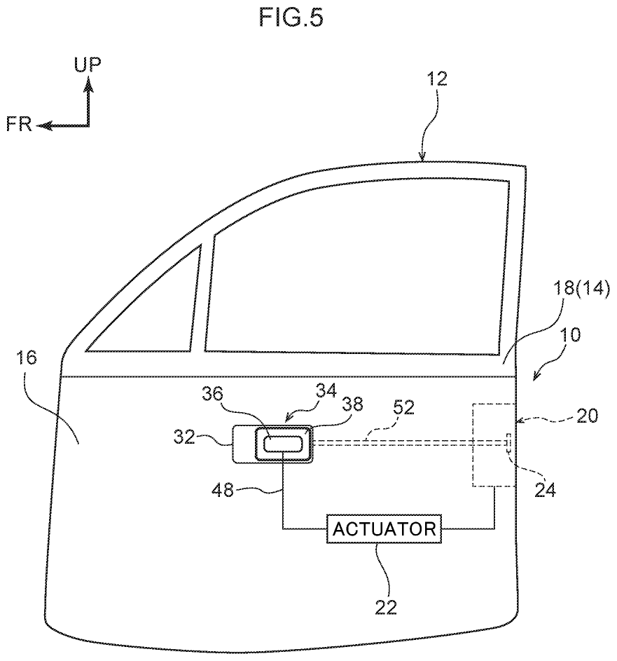

First, explanation follows regarding an outline of configuration a front side door 12 (referred to hereafter as side door 12), serving as a vehicle door provided with a vehicle door latch unlocking device 10 (referred to hereafter as door latch unlocking device 10) according to the first exemplary embodiment, with reference to FIG. 4 and FIG. 5. In the first exemplary embodiment, explanation follows regarding an example in which the door latch unlocking device 10 is provided to a front side door disposed on the driver's seat side of a right hand drive vehicle.

In a state in which the side door 12 is closing off a door opening provided in a vehicle body, not illustrated in the drawings (i.e., in a closed state of the side door 12), a width direction of the side door 12 (door width direction) is aligned with the vehicle front-rear direction, a thickness direction of the side door 12 (door thickness direction) is aligned with the vehicle width direction, and a vertical direction of the side door 12 (door vertical direction) is aligned with the vehicle vertical direction. In the following explanation, reference to the door width direction, door thickness direction, and door vertical direction each refer to the directions when the side door 12 is in the closed state.

As illustrated in FIG. 5, the side door 12 includes a door body 14 configuring a main section of the side door 12, and a resin door trim 16 configuring a vehicle cabin interior side section of the side door 12. The door body 14 includes a metal door outer panel, not illustrated in the drawings, configuring a vehicle width direction outer side section of the side door 12, and a metal door inner panel 18, configuring a vehicle width direction inner side section of the side door 12. The door outer panel extends in the vehicle vertical direction and the vehicle front-rear direction, and is curved so as to protrude toward the vehicle width direction outer side at a vehicle front-rear direction central portion as viewed in cross-section along the vehicle vertical direction, and so as to protrude toward the vehicle width direction outer side at a vehicle vertical direction central portion as viewed in cross-section along the vehicle front-rear direction.

The door inner panel 18 extends in the vehicle vertical direction and the vehicle front-rear direction, and is formed with service holes, employed when performing maintenance operations at plural locations. A peripheral edge portion of the door inner panel 18 is joined to a peripheral edge portion of the door outer panel by hemming, such that an internal space with depth in both the vehicle front-rear direction and vehicle width direction is formed between the door outer panel and the door inner panel 18. An electric actuator 22 configuring part of a lock device 20 and the door latch unlocking device 10 is disposed inside the door body 14. Note that a portion on one door width direction side of the side door 12 (on the vehicle front side) is coupled to the vehicle body through a hinge, not illustrated in the drawings, so as to be capable of swinging about the vehicle vertical direction.

The lock device 20 is disposed at an end portion on another door width direction side (vehicle rear side) of the door body 14, and includes a door latch 24. In the closed state of the side door 12, the door latch 24 engages with a striker provided to the vehicle body, not illustrated in the drawings. Namely, the side door 12 is placed in a locked state by engaging the door latch 24 with the striker.

The electric actuator 22 includes a motor, not illustrated in the drawings, and is coupled to the lock device 20. The electric actuator 22 is driven to actuate the door latch 24.

As illustrated in FIG. 4, the door trim 16 configures a styling face on the vehicle cabin interior side of the side door 12. More specifically, the door trim 16 includes a door trim body 26 that has a sheet shape covering the door inner panel 18 as viewed from the vehicle cabin interior side, and an armrest 28 that is integrally provided to the door trim body 26.

The armrest 28 bulges from the door trim body 26 toward one door thickness direction side (the vehicle width direction inner side) at a door vertical direction central portion of the door trim body 26. The armrest 28 has a substantially rectangular block shaped external profile extending in the door width direction. A recess 30 is provided to the armrest 28 so as to be recessed toward the vehicle lower side from an upper face 28A configuring a vehicle upper side portion of the armrest 28, and so as to extend along the door trim body 26. A portion of the armrest 28 on the one door thickness direction side of the recess 30 is configured as a pull handle 28B capable of being grasped by an occupant due to the recess 30 being provided to the armrest 28.

In the first exemplary embodiment, as illustrated in FIG. 1, a side face 28B1 configuring a portion on the one door thickness direction side of the pull handle 28B is provided with a bezel 32 and an unlocking unit 34 that configure parts of the door latch unlocking device 10. Detailed explanation follows regarding the bezel 32 and the unlocking unit 34, these being relevant portions of the first exemplary embodiment.

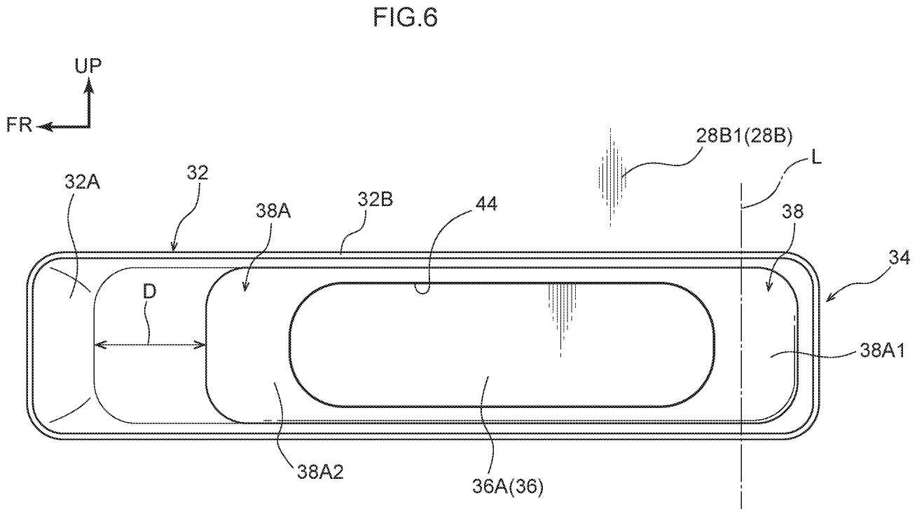

As illustrated in FIG. 6, the bezel 32 includes a bezel main body 32A and a frame 32B, these being main components of the bezel 32. The bezel main body 32A has a rectangular shape extending in the door width direction as viewed from the one door thickness direction side, and is formed in a box shape opening toward the one door thickness direction side. When the bezel main body 32A is considered as part of the pull handle 28B, the bezel main body 32A may be considered as a recess that is provided to the pull handle 28B and recessed toward the other door thickness direction side.

The frame 32B is configured in a substantially rectangular frame shape following a peripheral edge portion on the one door thickness direction side of the bezel main body 32A as viewed from the one door thickness direction side, and is integrally provided to the bezel main body 32A. Namely, as viewed from the one door thickness direction side, the bezel main body 32A is positioned at the inner side of the frame 32B. The unlocking unit 34 is attached to the bezel 32 so as to be contained at the inner side of the bezel main body 32A.

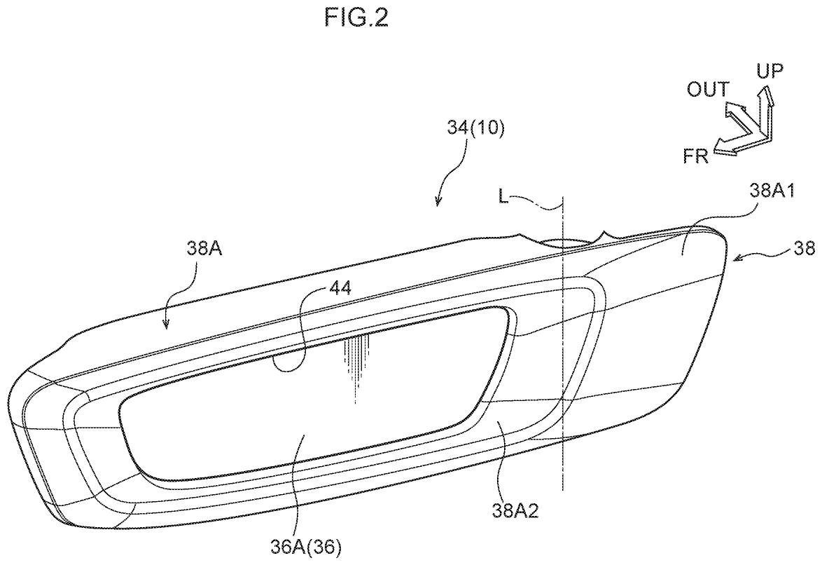

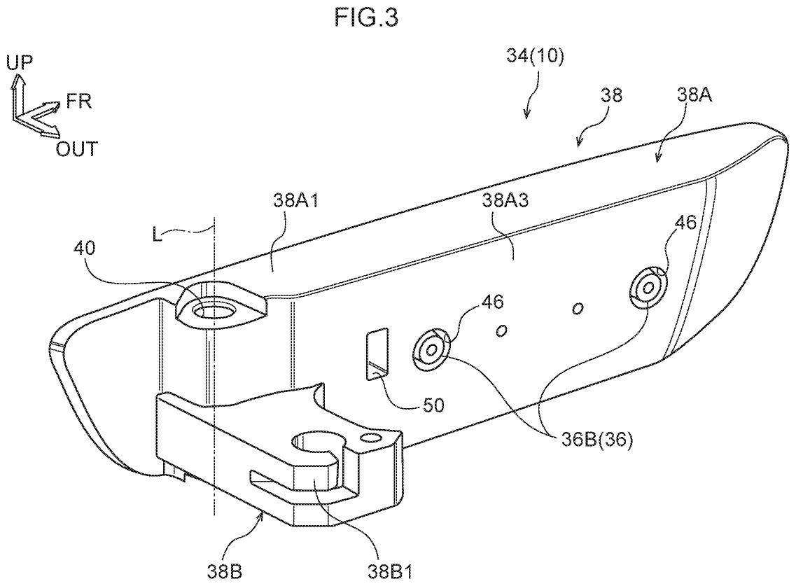

As illustrated in FIG. 2 and FIG. 3, the unlocking unit 34 includes a push switch 36, serving as an input section, and an inside handle 38, serving as an operation section.

The push switch 36 has a rectangular external profile extending in the door width direction as viewed along the door thickness direction, and is electrically connected to the electric actuator 22 mentioned above. A contact face 36A of the push switch 36 faces toward an occupant, and the push switch 36 is capable of outputting an input signal to the electric actuator 22 when pressed in the door thickness direction by the hand of the occupant.

When an input signal is input to the electric actuator 22 from the push switch 36 when the side door 12 has been placed in the locked state by the door latch 24, the electric actuator 22 is driven and the engaged state between the door latch 24 and the striker is unlocked. Namely, when the push switch 36 is pressed in a state in which the side door 12 is locked and the electric actuator 22 is in a state capable of actuating, the side door 12 is placed in an unlocked state.

The inside handle 38 includes a handle main body 38A and an extension portion 38B integrally provided to the handle main body 38A, these being relevant portions of the inside handle 38. The handle main body 38A is configured in an overall rectangular shape extending in the door width direction as viewed along the door thickness direction, and is configured in a plate shape with a predetermined thickness in the door thickness direction.

An insertion portion 40 is provided to an end portion 38A1 on the other door width direction side of the handle main body 38A. The insertion portion 40 penetrates the door width direction other side end portion 38A1 in the door vertical direction, and the insertion portion 40 is anchored to a non-illustrated shaft provided to the pull handle 28B. Accordingly, as illustrated in FIG. 1, the inside handle 38 is capable of turning with respect to the pull handle 28B about the door vertical direction (axis L). Namely, the inside handle 38 is capable of turning in a direction in which the occupant presses the push switch 36 with their hand.

Moreover, as illustrated in FIG. 6, in an attached state of the inside handle 38 to the pull handle 28B, the inside handle 38 and the push switch 36 are contained at the inner side of the frame 32B of the bezel 32 as viewed from the one door thickness direction side. Namely, the unlocking unit 34 is contained at the inner side of the frame 32B when viewed by an occupant in a seated state on a seat 42, serving as a vehicle seat (see FIG. 4). Moreover, an end portion on the one door width direction side of the handle main body 38A is in a state disposed at a separation D in the door width direction from an end portion on the one door width direction side of the frame 32B. The separation D is set to a size that allows a finger of the hand of the occupant to enter.

In addition, a recess 44 is provided to the handle main body 38A so as to be recessed toward the other door thickness direction side (i.e., a vehicle width direction outer side) from a front face 38A2 configuring a portion on the one door thickness direction side of the handle main body 38A. The push switch 36 is disposed inside the recess 44. Namely, the handle main body 38A has a frame shape following a peripheral edge portion of the push switch 36 as viewed from the one door thickness direction side.

More specifically, as illustrated in FIG. 3, a pair of insertion portions 46 are provided to a back face 38A3, configuring a portion on the other door thickness direction side of the handle main body 38, so as to penetrate the back face 38A3 in the door thickness direction. The insertion portions 46 are disposed at a separation from each other in the door width direction. A pair of circular cylinder shaped projections 36B that are capable of being inserted through the insertion portions 46 are provided on the opposite side of the push switch 36 to the contact face 36A. The push switch 36 fits into the recess 44 in a state in which in which the projections 36B are inserted into the insertion portions 46, and tapping screws, not illustrated in the drawings, are fastened to the projections 36B from the back face 38A3 side of the handle main body 38A, thereby fixing the push switch 36 to the handle main body 38A.

An insertion portion 50 into which a harness 48 (see FIG. 5) extending from the push switch 36 is capable of being inserted is provided to the back face 38A3 of the handle main body 38A. The harness 48 extending from the insertion portion 50 is connected to the electric actuator 22.

The extension portion 38B is configured with a substantially rectangular block shape extending from the back face 38A3 side of the end portion 38A1 of the handle main body 38A toward the other door thickness direction side. An anchor portion 38B1 is provided at a leading end portion of the extension portion 38B. The anchor portion 38B1 has a hooked shape that extends curving from the other door width direction side toward the one door width direction side. Another end portion of a wire 52 (see FIG. 5) that is coupled directly or indirectly to the door latch 24 at one end is anchored to the anchor portion 38B1. Namely, the inside handle 38 is mechanically connected to the door latch 24 via the wire 52. Note that in order to aid understanding of the configuration of the inside handle 38, the harness 48 and the wire 52 are omitted from illustration in FIG. 3.

In the door latch unlocking device 10 configured as described above, when the inside handle 38 is turned, tension in the wire 52 is transmitted to the door latch 24, thus driving the door latch 24 and unlocking the engaged state between the door latch 24 and the striker. Namely, in the first exemplary embodiment, in the locked state of the side door 12, the side door 12 may also be placed in the unlocked state by operating the inside handle 38.

### Operation and Effects of First Exemplary Embodiment

Explanation follows regarding operation and advantageous effects of the first exemplary embodiment.

As illustrated in FIG. 1, in the first exemplary embodiment, the push switch 36 is provided to a vehicle cabin interior side portion of the side door 12. When the push switch 36 receives input from the hand of the occupant, the push switch 36 actuates based on this input and outputs an input signal. The electric actuator 22 is then driven based on the input signal output from the push switch 36, and the locked state of the side door 12 by the door latch 24 is unlocked.

In a state in which the electric actuator 22 does not actuate correctly, for example due to its battery running flat, it becomes necessary to unlock the locked state of the side door 12 by the door latch 24 without using electricity. It is preferable that the occupant be able to intuitively recognize the operation required in order to unlock the locked state of the door latch 24.

The first exemplary embodiment includes the inside handle 38 that is mechanically connected to the door latch 24, such that the locked state of the side door 12 by the door latch 24 may be unlocked by operation of the inside handle 38 by the hand of the occupant. Accordingly, the locked state of the side door 12 by the door latch 24 may be unlocked by the occupant operating the inside handle 38, even in a state in which the electric actuator 22 does not actuate correctly. Moreover, the inside handle 38 is provided at the peripheral edge portion of the push switch 36, making it easier for the occupant to recognize that the inside handle 38 is to be used to unlock the locked state of the side door 12 by the door latch 24, similarly to the push switch 36. Accordingly, the first exemplary embodiment enables the operation required in order to unlock the locked state of the side door 12 by the door latch 24 in a disabled state of the electric actuator 22 to be simplified, and also enables the occupant to intuitively recognize this operation.

Moreover, in the first exemplary embodiment, the push switch 36 is actuated by being pressed by the hand of the occupant, and the inside handle 38 is operated by being turned by force in the direction in which the push switch 36 is pressed by the hand of the occupant. The direction of input by the hand of the occupant may thus be set to the same direction for the push switch 36 and the inside handle 38. Accordingly, the first exemplary embodiment enables the occupant to easily recognize the operation method of the inside handle 38.

In the first exemplary embodiment, the bezel 32 is disposed at the vehicle cabin interior side portion of the side door 12, and the frame 32B is provided to the bezel 32. The push switch 36 and the inside handle 38 are contained at the inner side of the frame 32B when viewed by the occupant in a seated state on the seat 42. This makes it easier for the occupant to recognize the presence of the inside handle 38, and makes it easier to recognize that the inside handle 38 has a function similar to that of the push switch 36. The first exemplary embodiment thereby enables the occupant to easily recognize the location to be operated in order to unlock the locked state of the side door 12 by the door latch 24 in a state in which the electric actuator 22 does not actuate correctly.

Moreover, in the first exemplary embodiment, the armrest 28 including the pull handle 28B is provided at the vehicle cabin interior side portion of the side door 12. The push switch 36 and the inside handle 38 are disposed at the side face 28B1 on the vehicle width direction inner side of the pull handle 28B. This thereby enables the occupant to apply input to the push switch 36 or operate the pull handle 28B while grasping the pull handle 28B. Accordingly, the first exemplary embodiment enables a smooth operation for the occupant from the operation to unlock the locked state of the side door 12 by the door latch 24 until opening of the side door 12.

In the first exemplary embodiment, the bezel main body 32A is provided to the pull handle 28B. The bezel main body 32A is positioned at the inner side of the frame 32B as viewed from the vehicle width direction inner side, and is recessed toward the vehicle width direction outer side. This enables a space into which the occupant is able to insert a finger of their hand to be secured at a location where the inside handle 38 is provided to the pull handle 28B, and thereby enables the occupant to hook the finger of their hand around the inside handle 38 to operate the inside handle 38. The first exemplary embodiment thereby enables easy operation of the inside handle 38 while the occupant is grasping the pull handle 28B.

Additionally, in the first exemplary embodiment, the inside handle 38 has a frame shape as viewed from the vehicle width direction inner side, and a vehicle rear side portion of the inside handle 38 is supported by the pull handle 28B so as to be capable of turning about the vehicle vertical direction. A vehicle front side portion of the inside handle 38 is disposed at the separation D in the vehicle front-rear direction from a vehicle front side portion of the frame 32B. This thereby enables the occupant to turn the inside handle 38 about the vehicle vertical direction while the occupant is grasping the pull handle 28B and has inserted a finger of their hand between the vehicle front side portion of the frame 32B and the vehicle front side portion of the inside handle 38. The first exemplary embodiment thereby enables the ease of operation of the inside handle 38 to be improved.

Moreover, in the first exemplary embodiment, the push switch 36 and the inside handle 38 are integrated to one another. This enables a reduction in the number of components disposed on the styling face on the vehicle cabin interior side of the side door 12, and enables an aesthetic improvement of the vehicle cabin interior in comparison to a configuration in which the push switch 36 and the inside handle 38 are disposed at separate locations. Moreover, the layouts of the wire 52 and the harness 48 may be simplified in comparison to configurations in which the push switch 36 and the inside handle 38 are disposed at separate locations to each other, which enables the configuration of the side door 12 to be simplified as a result, for example by reducing the number of service holes provided in the door inner panel 18.

### Modified Example of First Exemplary Embodiment

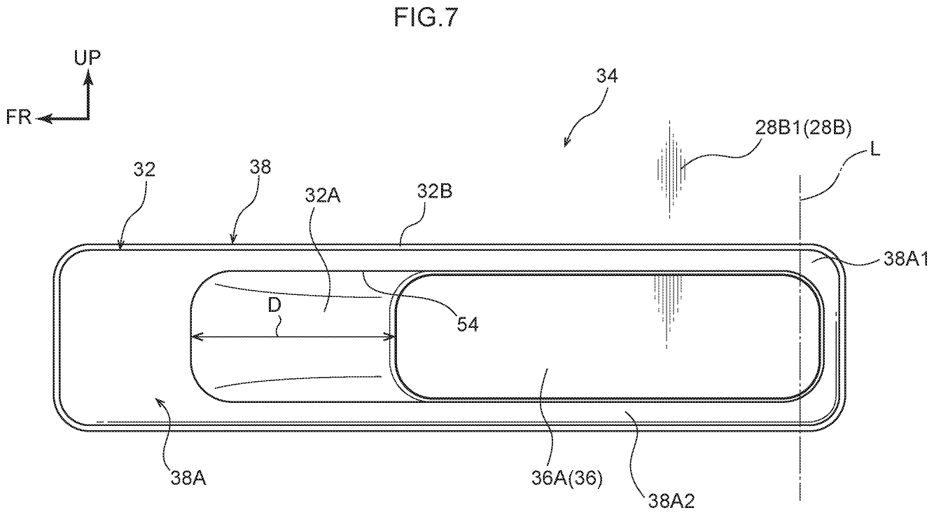

In the first exemplary embodiment, the shape of the inside handle 38 may be modified as appropriate. For example, as illustrated in FIG. 7, the handle body 38A may be configured such that a portion on the one door width direction side follows a portion on the one door width direction side of the frame 32B of the bezel 32, and a pierce-through portion 54 is provided on the handle main body 38A so as to be adjacent to the push switch 36. A separation D in the door width direction may be secured between the portion on the one door width direction side of the handle main body 38A and the push switch 36.

Such a configuration enables the occupant to turn the inside handle 38 about the vehicle vertical direction in a state in which in which a finger of their hand has been inserted into the pierce-through portion 54. Accordingly, the ease of operation of the inside handle 38 may be improved regardless of the shape of the bezel 32.

### Second Exemplary Embodiment

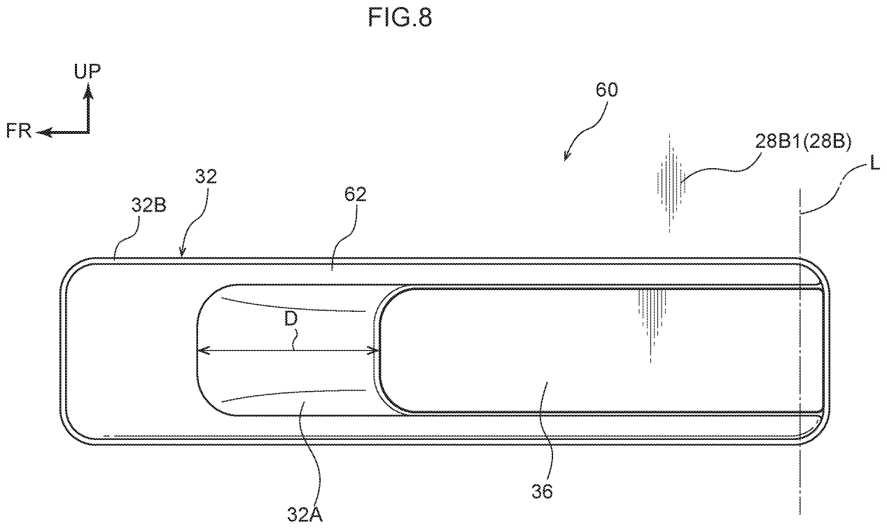

Explanation follows regarding a second exemplary embodiment of a vehicle door latch unlocking device according to the disclosure, with reference to FIG. 8. Note that components equivalent to those of the first exemplary embodiment described above are allocated the same reference numerals, and explanation thereof is omitted.

A vehicle door latch unlocking device 60 according to the second exemplary embodiment has a similar basic configuration as the first exemplary embodiment, except in the respect that in the vehicle door latch unlocking device 60, the push switch 36 and an inside handle 62 serving as an operation section are provided separately to each other.

Specifically, the inside handle 62 is configured in a substantially C shape opening toward the other door width direction side as viewed from the one door thickness direction side. An end portion on the other door width direction side of the inside handle 62 is supported by the pull handle 28B through a non-illustrated shaft extending in the door vertical direction. The inside handle 62 is thus configured capable of turning about the door vertical direction (axis L) with respect to the bezel 32.

The push switch 36 is fixed to the bezel 32 by a fixing member, not illustrated in the drawings. In the second exemplary embodiment, a non-illustrated insertion portion through which the harness 48 is inserted is provided to the bezel 32. Note that in the second exemplary embodiment, a separation D in the door width direction is secured between one door width direction side portion of the inside handle 62 and the push switch 36.

Such a configuration enables the push switch 36 to be fixed to the door body 14, and enables the degrees of freedom for layout of the harness 48 and the like to be secured.

### First Modified Example of Second Exemplary Embodiment

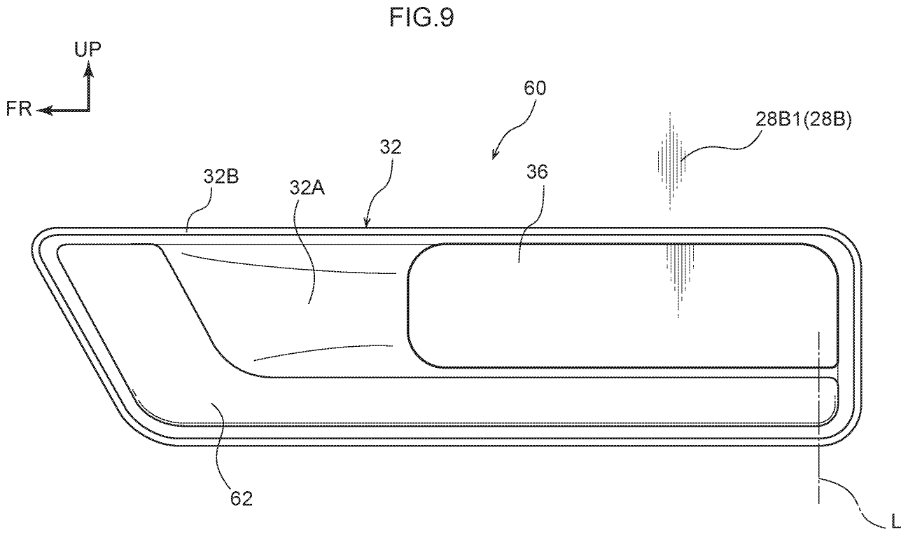

In the second exemplary embodiment, the shape of the inside handle 62 may be modified as appropriate. For example, as illustrated in FIG. 9, a door upper side portion of the inside handle 62 may be omitted, and the inside handle 62 may be configured in an L shape as viewed from the one door thickness direction side. Such a configuration enables the ease of operation of the inside handle 62 to be secured, regardless of the thickness of the fingers of the occupant, for example.

### Second Modified Example of Second Exemplary Embodiment

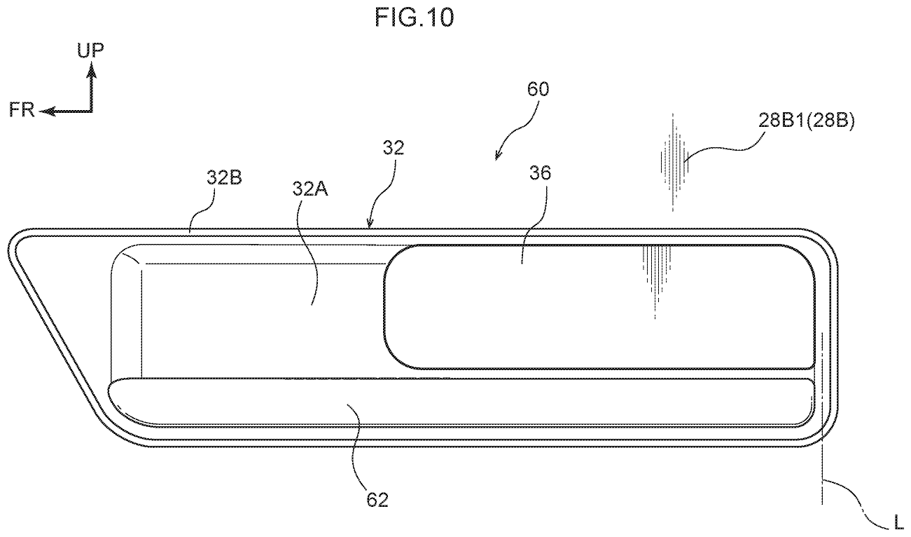

Moreover, as illustrated in FIG. 10, in the second exemplary embodiment, the inside handle 62 may be disposed at the door lower side of and adjacent to the push switch 36 as viewed from the one door thickness direction side, and the inside handle 62 may be configured in a plate shape extending in a straight line along the door width direction.

Such a configuration enables the configuration of the inside handle 62 to be simplified in accordance with the configuration of components such as the bezel 32 and the push switch 36 disposed peripherally to the inside handle 62.

### Supplementary Explanation of Above Exemplary Embodiments

(1) In the exemplary embodiments described above, the push switch 36 is employed as an input section; however, there is no limitation thereto. For example, a contact sensor or a touch panel may be employed instead of the push switch 36, in accordance with the configuration of the vehicle cabin interior. The shape of the inside handle is not limited to those described above, and may be modified as appropriate in accordance with the configuration of the vehicle cabin interior and so on.

(2) In the exemplary embodiments described above, the push switch 36, the bezel 32, and the inside handle are provided to the side face 28B1 of the pull handle 28B. However, there is no limitation thereto. Namely, the push switch 36, the bezel 32, and the inside handle may be disposed at the upper face 28A of the armrest 28 in accordance with the configuration of the door trim 16 and the like, as long as the push switch 36 and the inside handle are positioned at the inner side of the frame 32B of the bezel 32 when viewed by the occupant in a seated state on a seat.

(3) Moreover, in the exemplary embodiments described above, the bezel 32 includes the bezel main body 32A and the frame 32B. However, there is no limitation thereto. For example, the bezel 32 may be configured by the frame 32B alone in accordance with the interior décor of the vehicle, for example, with a recess corresponding to the bezel main body 32A being provided to the pull handle 28B.

(4) Furthermore, in the exemplary embodiments described above, the vehicle door latch unlocking device 10, 60 is provided to the side door 12. However, the vehicle door latch unlocking device 10, 60 may, for example, be provided to another door in accordance with the specifications of the vehicle.

What is claimed is:

1. A vehicle door latch unlocking device comprising:
an input section that is provided to a vehicle cabin interior side portion of a vehicle door, the input section being capable of outputting an input signal in response to an input from a hand of an occupant;
an electric actuator that is driven based on the input signal, and that is capable of unlocking a lock state of the vehicle door locked by a door latch; and
an operation section that is provided at a peripheral edge portion of the input section, the operation section being mechanically connected to the door latch, and being capable of unlocking the locked state as a result of being operated by the hand of the occupant.

2. The vehicle door latch unlocking device of claim 1, wherein:
the input section is actuated by being pressed by the hand of the occupant; and
the operation section becomes operable by being turned by force in a direction in which the input section is pressed by the hand of the occupant.

3. The vehicle door latch unlocking device of claim 1, further comprising a frame that is provided to a vehicle cabin interior side portion of the vehicle door, wherein:
the input section and the operation section are contained at an inner side of the frame when viewed by the occupant in a seated state on a vehicle seat.

4. The vehicle door latch unlocking device of claim 1, further comprising an armrest that is provided to a vehicle cabin interior side portion of the vehicle door, and that comprises a pull handle, wherein:
the input section and the operation section are disposed at a side face on a vehicle width direction inner side of the pull handle.

5. The vehicle door latch unlocking device of claim 3, further comprising an armrest that is provided to a vehicle cabin interior side portion of the vehicle door, and that comprises a pull handle, wherein:
the input section and the operation section are disposed at a side face on a vehicle width direction inner side of the pull handle.

6. The vehicle door latch unlocking device of claim 5, wherein a recess is provided to the pull handle so as to be recessed toward a vehicle width direction outer side at the inner side of the frame as viewed from the vehicle width direction inner side.

7. The vehicle door latch unlocking device of claim 6, wherein:
the operation section has a frame shape as viewed from the vehicle width direction inner side;
a vehicle rear side portion of the operation section is supported by the pull handle so as to be capable of turning about a vehicle vertical direction; and
a vehicle front side portion of the operation section is disposed at a separation in a vehicle front-rear direction from a vehicle front side portion of the frame.
